(19) United States
(12) Patent Application Publication
(10) Pub. No.: US 2017/0236059 A1
(43) Pub. Date: Aug. 17, 2017

(54) APPARATUS AND METHOD FOR GENERATING WEIGHT ESTIMATION MODEL, AND APPARATUS AND METHOD FOR ESTIMATING WEIGHT

(71) Applicant: SAMSUNG ELECTRONICS CO., LTD., Suwon-si (KR)

(72) Inventor: So Young LEE, Daejeon (KR)

(73) Assignee: SAMSUNG ELECTRONICS CO., LTD., Suwon-si (KR)

(21) Appl. No.: 15/235,997

(22) Filed: Aug. 12, 2016

(30) Foreign Application Priority Data
Feb. 17, 2016 (KR) 10-2016-0018687

(51) Int. Cl. G06N 3/08

(52) U.S. Cl. CPC G06N 3/086

(57) ABSTRACT

An apparatus for generating the weight estimation model includes a training data collection unit that collects training data, the training data including skin spectrum information and weight information of a plurality of objects, and a model generation unit that generates the weight estimation model, used for a spectrum-based weight estimation, through machine learning based on the collected training data.

### CROSS-REFERENCE TO RELATED APPLICATION(S)

This application claims priority from Korean Patent Application No. 10-2016-0018687, filed on Feb. 17, 2016, in the Korean Intellectual Property Office, the disclosure of which is incorporated herein by reference in its entirety.

### BACKGROUND

1. Field

Apparatuses and methods consistent with exemplary embodiments relate to an apparatus and a method for generating a weight estimation model and an apparatus and a method for estimating a weight.

2. Description of Related Art

Modern days, people who are highly concerned about their health want to increase or decrease body weight. However, it is very difficult to measure body weight on a daily basis in a busy schedule. Therefore, it is common that people may experience a rapid increase in body weight within a few days if they forget to measure the body weight.

In addition, considering that obesity may lead to various kinds of diseases, it is important to maintain proper weight. Particularly, with the emergence of an aging society, maintaining proper weight is becoming more important to lead a healthy life.

Therefore, there is a need for a technology that can conveniently and simply measure and monitor weight.

### SUMMARY

One or more exemplary embodiments provide an apparatus and a method for generating a weight estimation model which are used in estimating a weight based on a skin spectrum, and an apparatus and a method for estimating a weight based on a skin spectrum.

In one general aspect, there is provided an apparatus for generating a weight estimation model including: a training data collection unit that collects training data, the training data comprising skin spectrum information and weight information of a plurality of objects; and a model generation unit that generates the weight estimation model, used for spectrum-based weight estimation, through machine learning based on the collected training data.

Here, the model generation unit may generate the weight estimation model through the machine learning, in which the skin spectrum information is used as an input and the weight information is used as an output.

Also, the training data may further contain at least one of age information, height information, gender information, and bio impedance information of an object.

Also, the model generation unit may generate the weight estimation model through the machine learning, in which the skin spectrum information and the at least one of the age information, the height information, the gender information, and the bio impedance information are used as inputs and the weight information is used as an output.

Also, an algorithm used to perform the machine learning may include at least one of partial least squares regression, linear regression, neural network, decision tree, genetic algorithm, genetic programming, K-nearest neighbor, radial basis function network, random forest, support vector machine, and deep-learning.

In another general aspect, there is provided a method for generating a weight estimation model including: collecting training data, the training data comprising skin spectrum information and weight information of a plurality of objects; and generating the weight estimation model, used for spectrum-based weight estimation, through machine learning based on the collected training data.

Here, the generating of the weight estimation model may include generating the weight estimation model through the machine learning, in which the skin spectrum information is used as an input and the weight information is used as an output.

Also, the training data may further contain at least one of age information, height information, gender information, and bio impedance information of an object.

Also, the generating of the weight estimation model may include generating the weight estimation model through the machine learning, in which the skin spectrum information and the at least one of the age information, the height information, the gender information, and the bio impedance information are used as inputs and the weight information is used as an output.

Also, an algorithm used to perform the machine learning may include at least one of partial least squares regression, linear regression, neural network, decision tree, genetic algorithm, genetic programming, K-nearest neighbor, radial basis function network, random forest, support vector machine, and deep-learning.

In still another general aspect, there is provided an apparatus for estimating a weight including: a spectrum measurement unit that measures a skin spectrum of a user; and a weight estimation unit that estimates a weight of the user using a weight estimation model based on the measured skin spectrum.

Here, the weight estimation model may be generated through machine learning based on training data, the training comprising skin spectrum information and weight information of a plurality of objects.

Also, the training data may further contain at least one of age information, height information, gender information, and bio impedance information of the plurality objects.

Also, the weight estimation unit may estimate the weight of the user further based on at least one of age information, height information, gender information, and bio impedance information of the user.

Also, an algorithm to perform the machine learning may include at least one of partial least squares regression, linear regression, neural network, decision tree, genetic algorithm, genetic programming, K-nearest neighbor, radial basis function network, random forest, support vector machine, and deep-learning.

### BRIEF DESCRIPTION OF THE DRAWINGS

The above and/or other aspects will be more apparent by describing certain example embodiments with reference to the accompanying drawings.

FIG. 1 is a block diagram illustrating an exemplary embodiment of an apparatus for generating a weight estimation model.

FIG. 2 is a block diagram illustrating an exemplary embodiment of an apparatus for estimating a weight.

FIG. 3 is a block diagram illustrating another exemplary embodiment of an apparatus for estimating a weight.

FIG. 4 is a flowchart illustrating an exemplary embodiment of a method for generating a weight estimation model.

FIG. 5 is a flowchart illustrating an exemplary embodiment of a method for estimating a weight.

FIG. 6 is a flowchart illustrating another exemplary embodiment of a method for estimating a weight.

FIG. 7 is a block diagram illustrating another exemplary embodiment of an apparatus for generating a weight estimation model.

FIG. 8 is a block diagram illustrating still another exemplary embodiment of an apparatus for estimating a weight.

FIG. 9 is a block diagram illustrating yet another exemplary embodiment of an apparatus 200 for estimating a weight.

FIG. 10 is a block diagram illustrating another exemplary embodiment of a method for generating a weight estimation model.

FIG. 11 is a flowchart illustrating still another exemplary embodiment of a method for estimating a weight.

FIG. 12 is a flowchart illustrating yet another exemplary embodiment of a method for estimating a weight.

### DETAILED DESCRIPTION

Hereinafter, the exemplary embodiments will be described in detail with reference to the accompanying drawings. In the following descriptions of possible embodiments operable from the invention, when some of the components and features of the exemplary embodiments are known and description thereof obscures the subject matter of the disclosure, the corresponding detailed description will be omitted. In addition, the terminology described below is defined considering functions in the disclosure and may vary according to a user's or operator's intention or usual practice. Thus, the meanings of the terminology should be interpreted based on the overall context of the present specification.

Throughout the drawings and the detailed description, unless otherwise described, the same drawing reference numerals will be understood to refer to the same elements, features, and structures. The relative size and depiction of these elements may be exaggerated for clarity, illustration, and convenience.

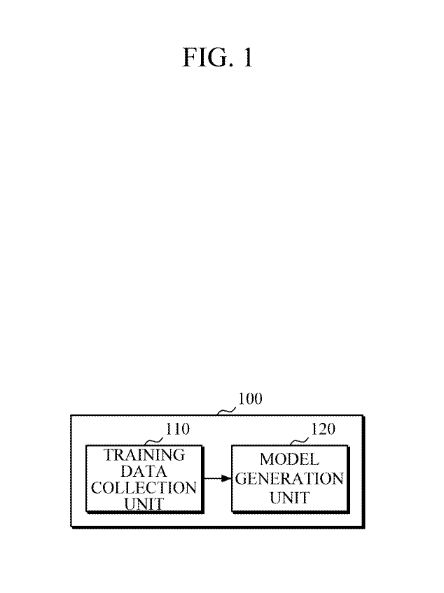

FIG. 1 is a block diagram illustrating an exemplary embodiment of an apparatus for generating a weight estimation model. The apparatus 100 for generating the weight estimation model according to an exemplary embodiment may be an apparatus for generating the weight estimation model which is used in estimating a user's weight based on a skin spectrum of the user.

Referring to FIG. 1, the apparatus 100 for generating the weight estimation model may include a training data collection unit 110 and a model generation unit 120.

The training data collection unit 110 may collect training data comprising skin spectrum information and weight information of a plurality of objects.

There is no particular limitation in a method in which the training data collection unit 110 collects the training data. That is, the training data collection unit 110 may simply receive and collect the skin spectrum information and weight information of the plurality of objects from an external device or collect the skin spectrum information by directly irradiating the plurality of objects with light and collect the weight information by directly measuring the weights of the plurality of objects.

The model generation unit 120 may generate the weight estimation model through machine learning based on the collected training data. For example, the model generation unit 120 may generate the weight estimation model through the machine learning using the skin spectrum information as an input and the weight information corresponding to the skin spectrum information, which is weight information of an object whose skin spectrum information is acquired, as a target (or as an output).

A machine learning algorithm may be one of partial least squares regression, linear regression, neural network, decision tree, genetic algorithm, genetic programming, K-nearest neighbor, radial basis function network, random forest, support vector machine, and deep-learning.

For example, when the weight estimation model is generated using the partial least squares regression, the generated weight estimation model may be expressed as Equation 1.

b₀+b₁A₁+b₂A₂+ . . . +bₙAₙ=W [Equation 1]

Here, W denotes a weight, Aₙ denotes absorbance in a wavelength n, and bₙ denotes a coefficient of Aₙ.

In addition, when generating the weight estimation model using the neural network, the model generation unit 120 may generate the weight estimation model using a typical back propagation method (for example, gradient descent algorithm, stochastic gradient descent algorithm, etc.).

According to an exemplary embodiment, to increase the accuracy of weight estimation, the apparatus 100 for generating the weight estimation model may generate the weight estimation model by further using additional information including age, height, gender, bio impedance, etc. of the object in addition to the skin spectrum information and the weight information. In this case, the training data collection unit 110 may collect the training data further comprising at least one of age information, height information, gender information, and bio impedance information of the object in addition to the skin spectrum information and the weight information, and the model generation unit 120 may generate the weight estimation model through the machine learning using, as inputs, the at least one of age information, height information, gender information, and bio impedance information of the object as well as the skin spectrum information and using the weight information of the object as a target.

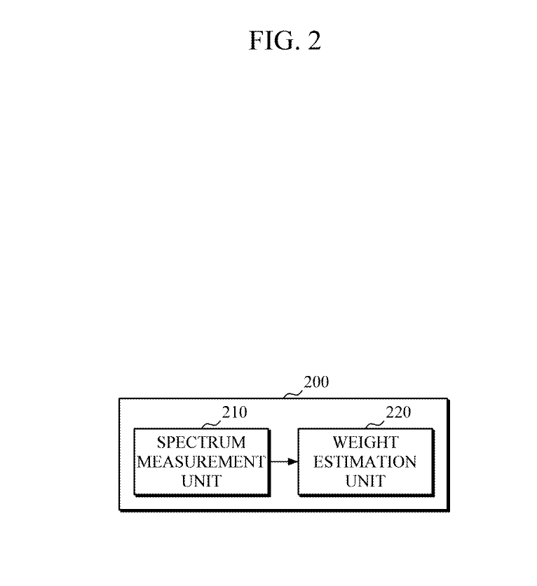

FIG. 2 is a block diagram illustrating an exemplary embodiment of an apparatus for estimating a weight. The apparatus 200 for estimating the weight is an apparatus that may estimate a weight of a user based on a skin spectrum of the user and estimates the user's weight using the weight estimation model generated by the apparatus 100 for generating the weight estimation model of FIG. 1. The apparatus 200 for estimating the weight may be implemented as a software module, a hardware module (e.g., manufactured in the form of a hardware chip), or a combination thereof, and mounted in an electronic device. The electronic device may include a mobile phone, a smart phone, a tablet, a laptop, a PDA (personal digital assistant), a PMP (portable multimedia player), a navigation, an MP3 player, a digital camera, a wearable device, etc. However, the electronic device is not limited to the above-described examples and may include a variety of devices.

Referring to FIG. 2, the apparatus 200 for estimating the weight may include a spectrum estimation unit 210 and a weight estimation unit 220.

The spectrum estimation unit 210 may estimate a user's skin spectrum. For example, the spectrum estimation unit 210 may irradiate the user's skin with light and detect light scattered by or reflected from the skin, thereby measuring the user's skin spectrum. To this end, the spectrum estimation unit 210 may include a spectroscope.

The weight estimation unit 220 may estimate a user's weight based on the measured user's skin spectrum using the weight estimation model generated in advance.

The weight estimation model may be generated through machine learning based on training data comprising skin spectrum information and weight information of a plurality of objects. Here, a machine learning algorithm may be one of partial least squares regression, linear regression, neural network, decision tree, genetic algorithm, genetic programming, K-nearest neighbor, radial basis function network, random forest, support vector machine, and deep-learning.

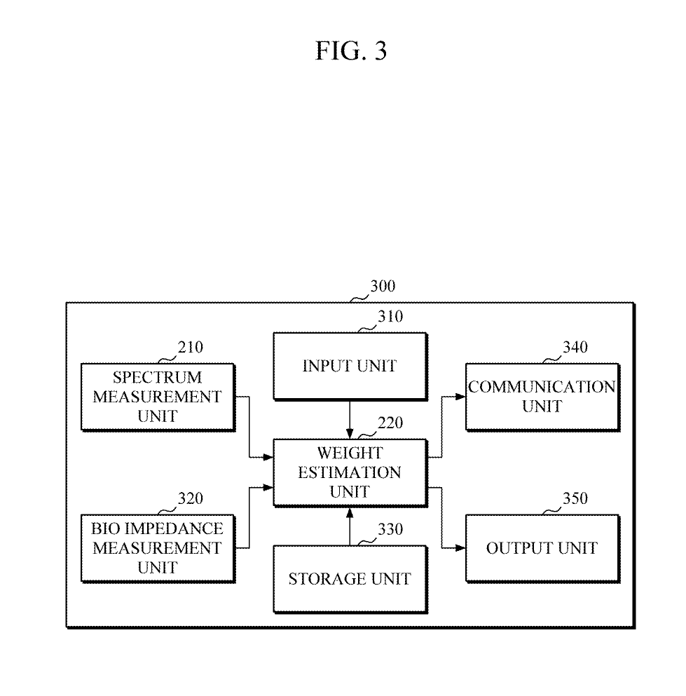

FIG. 3 is a block diagram illustrating another exemplary embodiment of an apparatus for estimating a weight.

Referring to FIGS. 2 and 3, compared to the apparatus 200 for estimating the weight of FIG. 2, the apparatus 300 for estimating the weight of FIG. 3 may further selectively include an input unit 310, a bio impedance measurement unit 320, a storage unit 330, a communication unit 340, and an output unit 350.

The input unit 310 may receive a variety of operation signals and a variety of user information used for the weight estimation from a user. The user information may be user related information which can be used in the weight estimation, and contain age, gender, height, and the like.

According to an exemplary embodiment, the input unit 310 may include a key pad, a dome switch, a touch pad (e.g., static pressure/power failure), a jog wheel, a jog switch, H/W bottoms, and the like. In particular, when a layer structure is formed with the touch pad and a display, this may be referred to as a touch screen.

The bio impedance estimation unit 320 may estimate a user's bio impedance. For example, the bio impedance estimation unit 320 may estimate the user's bio impedance using a BIA (bio impedance analyzer) method that applies a current to a user's body and measures electrical impedance of the user.

The storage unit 330 may store programs or commands for operations of the apparatus 200 for estimating the weight, and also store input/output data. In addition, the storage unit 330 may store the weight estimation model generated in advance. As described above in FIG. 1, the weight estimation model may be generated based on the training data comprising the skin spectrum information and weight information of the plurality of objects or generated based on the training data further comprising additional information including age, height, gender, bio impedance, etc. of the object in addition to the skin spectrum information and weight information of the plurality of objects.

The storage unit 330 may include a flash memory type memory, a hard disk type memory, a multimedia card micro type memory, a card type memory (e.g., SD or XD memory), a RAM (random access memory), an SRAM (static random access memory), a ROM (read only memory), an EEPROM (electrically erasable programmable read only memory), a PROM (programmable read only memory), a magnetic memory, a magnetic disk, an optical disk, and the like. In addition, the apparatus 300 for estimating the weight may operate an external storage medium such as a web storage or the like which performs a storage function of the storage unit 330 on the Internet.

The communication unit 340 may perform communication with an external device. For example, the communication unit 340 may transmit the information received from a user through the input unit 310, the user's bio impedance information measured by the bio impedance measurement unit 320, the skin spectrum information measured by the spectrum measurement unit 210, the user's weight information estimated by the weight measurement unit 220, and the like to the external device, or receive a variety of information which can be used in the user's weight estimation from the external device.

The external device may be a medical device using the estimated weight information, a printer for outputting the result, or a display device for displaying the estimated weight information. In addition to these, the external device may be a smartphone, a mobile phone, a PDA (personal digital assistant), a laptop, a PC, and other mobile or non-mobile computing devices and is not limited thereto.

The communication unit 340 may communicate with the external device using Bluetooth communication, BLE (Bluetooth low energy) communication, NFC (near field communication), WLAN (wireless local area network) communication, Zigbee communication, IrDA (infrared data association) communication, WFD (Wi-Fi direct) communication, UWB (ultra-wideband) communication, Ant+ communication, Wi-Fi communication, RFID (radio frequency Identification) communication, or the like. However, this is merely an example, and the exemplary embodiments are not limited thereto.

The output unit 350 may output a weight estimation result. According to an exemplary embodiment, the output unit 350 may output the weight estimation result in at least one of audible, visual, and tactile methods. For example, the output unit 340 may output the weight estimation result using voice, text, vibration, and the like. To this end, the output unit 340 may include a display, a speaker, a vibrator, and the like.

The weight estimation unit 220 may estimate the user's weight using the weight estimation model based on the user's skin spectrum information estimated by the spectrum estimation unit 210, the user's bio impedance information estimated by the bio impedance estimation unit 320, and the user information input through the input unit 310. That is, the weight estimation unit 220 may estimate the user's weight further using the bio impedance information, the user information (e.g., height, age, gender, and the like) in addition to the user's skin spectrum information.

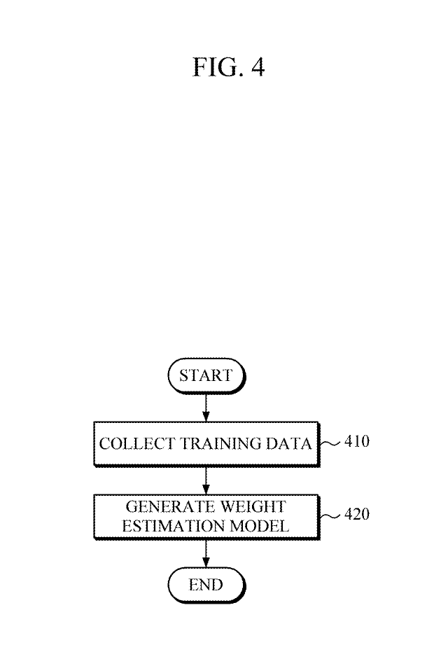

FIG. 4 is a flowchart illustrating an exemplary embodiment of a method for generating a weight estimation model.

Referring to FIGS. 1 and 4, in operation 410, the apparatus 100 for generating the weight estimation model may collect training data comprising skin spectrum information and weight information of a plurality of objects.

In operation 420, the apparatus 100 for generating the weight estimation model may generate a weight estimation model through machine learning based on the collected training data. For example, the apparatus 100 for generating the weight estimation model may generate the weight estimation model through the machine learning using the skin spectrum information as an input and the weight information corresponding to the skin spectrum information, that is, weight information of an object whose skin spectrum information is acquired, as a target.

A machine learning algorithm may be one of partial least squares regression, linear regression, neural network, decision tree, genetic algorithm, genetic programming, K-nearest neighbor, radial basis function network, random forest, support vector machine, and deep-learning.

According to an exemplary embodiment, the apparatus 100 for generating the weight estimation model may generate the weight estimation model further using additional information including age, height, gender, bio impedance, etc. of the object in addition to the skin spectrum information and the weight information. In this case, the apparatus 100 for generating the weight estimation model may collect the training data further comprising at least one of age information, height information, gender information, and bio impedance information of the object in addition to the skin spectrum information and the weight information, and generate the weight estimation model through machine learning using, as inputs, the at least one of the age information, height information, gender information, and bio impedance information of the object as well as the skin spectrum information and using the weight information as a target.

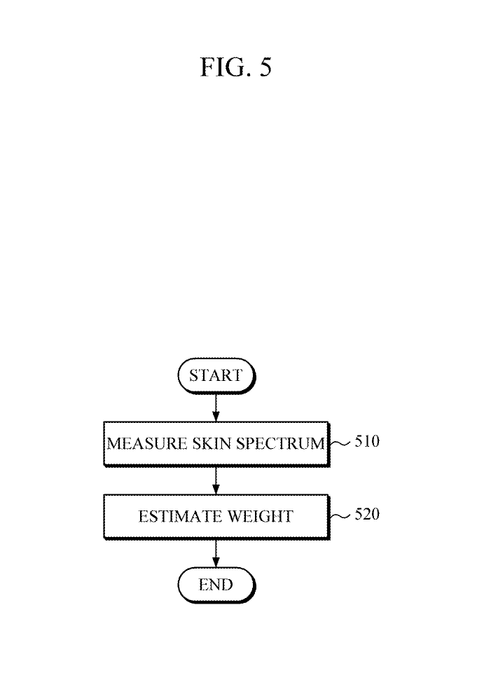

FIG. 5 is a flowchart illustrating an exemplary embodiment of a method for estimating a weight.

Referring to FIGS. 2 and 5, in operation 510, the apparatus 200 for estimating a weight may estimate a user's skin spectrum. For example, the apparatus 200 for estimating the weight may irradiate the user's skin with light and detect light scattered by or reflected from the skin, thereby measuring the user's skin spectrum.

In operation 520, the apparatus 200 for estimating the weight may measure a user's weight based on the measured user's skin spectrum using a weight estimation model generated in advance.

The weight estimation model may be generated through machine learning based on training data comprising skin spectrum information and weight information of a plurality of objects. Here, a machine learning algorithm may be one of partial least squares regression, linear regression, neural network, decision tree, genetic algorithm, genetic programming, K-nearest neighbor, radial basis function network, random forest, support vector machine, and deep-learning.

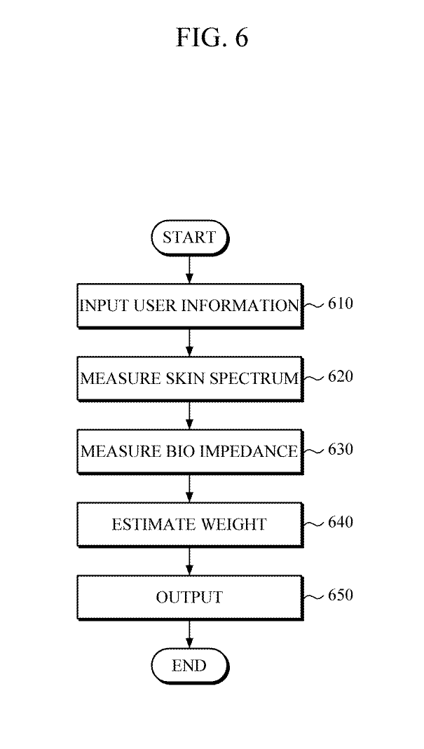

FIG. 6 is a flowchart illustrating another exemplary embodiment of a method for estimating a weight.

Referring to FIGS. 3 and 6, in operation 610, the apparatus 300 for estimating the weight may receive a variety of user information used in weight estimation. The user information is user related information which can be used in weight estimation and contain age, gender, height, and the like.

In operation 620, the apparatus 300 for estimating the weight may measure a user's skin spectrum.

In operation 630, the apparatus 300 for estimating the weight may measure a user's bio impedance. For example, the apparatus 300 for estimating the weight may measure the user's bio impedance using a BIA method that applies a current to a user's body and measures electrical impedance of the user.

In operation 640, the apparatus 300 for estimating the weight may estimate a user's weight using a weight estimation model based on the measured user's skin spectrum information, the measured user's bio impedance information, and the received user information. As described in FIG. 1, the weight estimation model may be generated based on training data comprising the skin spectrum information and weight information of the plurality of objects or generated based on the training data further comprising additional information including age, height, gender, bio impedance, etc. of the object in addition to the skin spectrum information and weight information of the plurality of objects.

In operation 650, the apparatus 300 for estimating the weight may output a weight estimation result. According to an exemplary embodiment, the apparatus 300 for estimating the weight may output the weight estimation result in at least one of audible, visual, and tactile methods. For example, the apparatus 300 for estimating the weight may output the weight estimation result using voice, text, vibration, and the like.

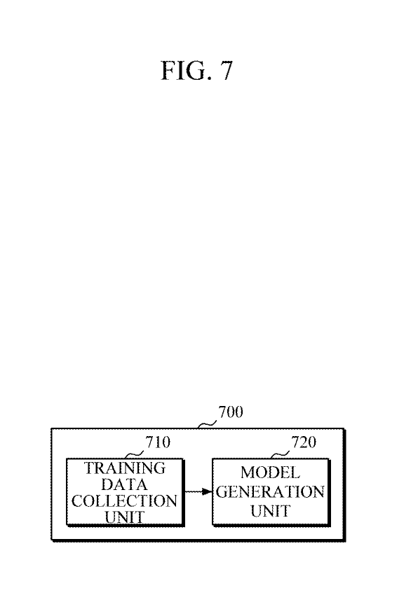

FIG. 7 is a block diagram illustrating another exemplary embodiment of an apparatus for generating a weight estimation model.

Referring to FIG. 7, an apparatus 700 for generating a weight estimation model may include a training data collection unit 710 and a model generation unit 720.

The training data collection unit 710 may collect training data comprising body composition analysis result information and weight information of a plurality of objects. The body composition analysis result information may contain an amount of protein, an amount of fat, an amount of water, and the like.

Here, there is no limitation to a method in which the training data collection unit 710 collects the training data. That is, the training data collection unit 110 may simply receive and collect the body composition analysis result information and weight information of the plurality of objects from an external device. Alternatively, the training data collection unit 110 may acquire a skin spectrum by directly irradiating the plurality of objects with light and then collect the body composition analysis result information by analyzing the skin spectrum as well as also collect the weight information by directly measuring weights of the plurality of objects.

The model generation unit 720 may generate the weight estimation model through machine learning based on the collected training data. For example, the model generation unit 720 may generate the weight estimation model through the machine learning using the body composition analysis result information as an input and the weight information corresponding to the body composition analysis result information as a target.

A machine learning algorithm may be one of partial least squares regression, linear regression, neural network, decision tree, genetic algorithm, genetic programming, K-nearest neighbor, radial basis function network, random forest, support vector machine, and deep-learning.

According to an exemplary embodiment, the apparatus 700 for generating the weight estimation model may generate the weight estimation model further using additional information including age, height, gender, bio impedance, etc. of the object in addition to the body composition analysis result information and the weight information. In this case, the training data collection unit 710 may collect the training data further comprising at least one of age information, height information, gender information, and bio impedance information of the object in addition to the body composition analysis result information and the weight information, and the model generation unit 720 may generate the weight estimation model through the machine learning using, as inputs, the at least one of the age information, the height information, the gender information, and the bio impedance information as well as the body composition analysis result information and using the weight information as a target.

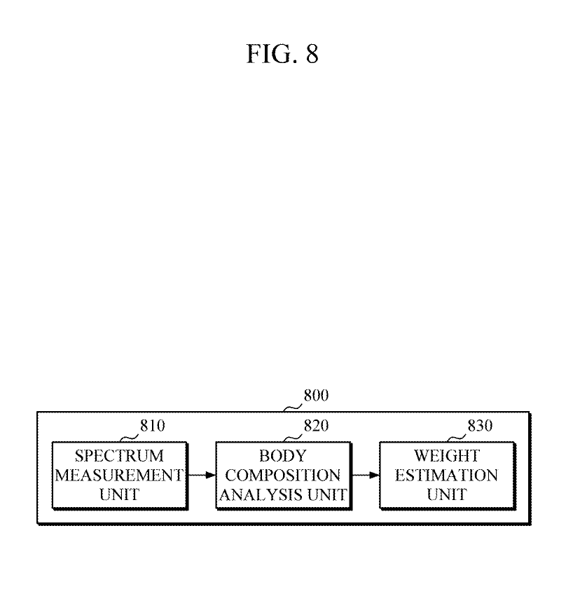

FIG. 8 is a block diagram illustrating still another exemplary embodiment of an apparatus for estimating a weight. An apparatus 800 for estimating a weight may be an apparatus that may estimate a user's weight using the weight estimation model generated by the apparatus 700 for generating the weight estimation model of FIG. 7.

Referring to FIG. 8, the apparatus 800 for estimating the weight may include a spectrum estimation unit 810, a body composition analysis unit 820, and a weight estimation unit 830.

The spectrum estimation unit 810 may measure a user's skin spectrum.

The body composition analysis unit 820 may analyze a user's body composition (for example, water, protein, fat, etc.) through the measured skin spectrum.

The weight estimation unit 830 may estimate the user's weight based on the body composition analysis result using the weight estimation model generated in advance.

The weight estimation model may be generated through machine learning based on training data comprising body composition analysis result information and weight information of a plurality of objects. Here, a machine learning algorithm may be one of partial least squares regression, linear regression, neural network, decision tree, genetic algorithm, genetic programming, K-nearest neighbor, radial basis function network, random forest, support vector machine, and deep-learning.

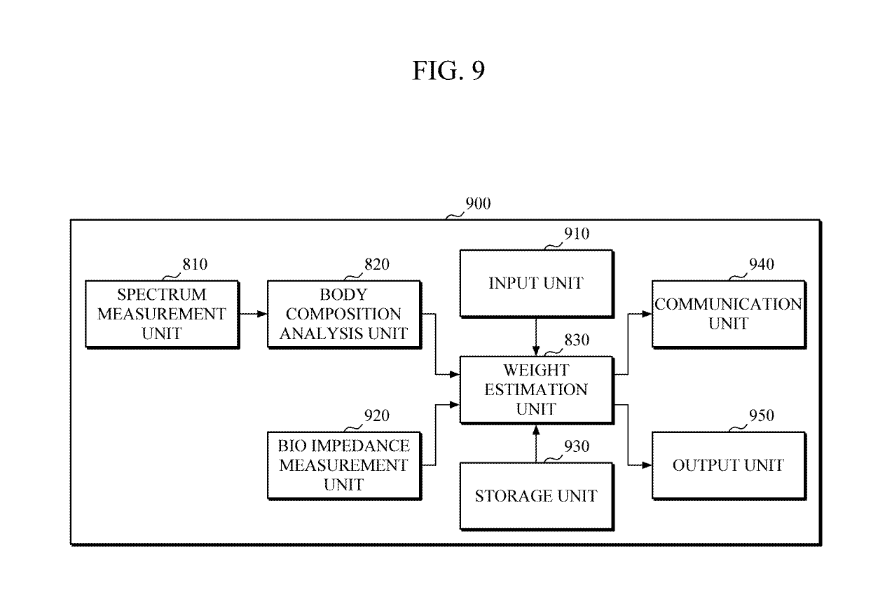

FIG. 9 is a block diagram illustrating yet another exemplary embodiment of the apparatus for estimating the weight.

Referring to FIGS. 8 and 9, compared to the apparatus 800 for estimating the weight of FIG. 8, an apparatus 900 for estimating a weight of FIG. 9 may further selectively include an input unit 910, a bio impedance measurement unit 920, a storage unit 930, a communication unit 940, and an output unit 950.

The input unit 910 may receive a variety of operation signals and a variety of user information used for the weight estimation from a user. The user information may be user related information which can be used in the weight estimation and contain age, gender, height, and the like.

The bio impedance measurement unit 920 may measure a user's bio impedance. For example, the bio impedance measurement unit 920 may measure the user's bio impedance using a BIA method that applies a current to a user's body and measures electrical impedance of the user.

The storage unit 930 may store programs or commands for operations of the apparatus 900 for estimating the weight and also store input/output data. In addition, the storage unit 930 may store the weight estimation model generated in advance. Here, as described above in FIG. 7, the weight estimation model may be generated based on the training data comprising the body composition analysis result information and weight information of the plurality of objects or generated based on the training data further comprising additional information including age, height, gender, bio impedance, etc. of the object in addition to the body composition analysis result information and weight information of the plurality of objects.

The communication unit 940 may perform communication with an external device. For example, the communication unit 940 may transmit the information received from the user through the input unit 901, the user's bio impedance information measured by the bio impedance measurement unit 920, the skin spectrum information measured by the spectrum measurement unit 810, the body composition analysis result information analyzed by the body composition analysis unit 820, the user's weight information estimated by the weight estimation unit 830, and the like to the external device or receive a variety of information which can be used in the user's weight estimation from the external device.

The output unit 950 may output a weight estimation result. According to an exemplary embodiment, the output unit 950 may output the weight estimation result in at least one of audible, visual, and tactile methods.

The weight estimation unit 830 may estimate the user's weight using the weight estimation model based on the body composition analysis result information of the body composition analysis unit 820, the user's bio impedance information measured by the bio impedance measurement unit 920, and the user information received through the input unit 910.

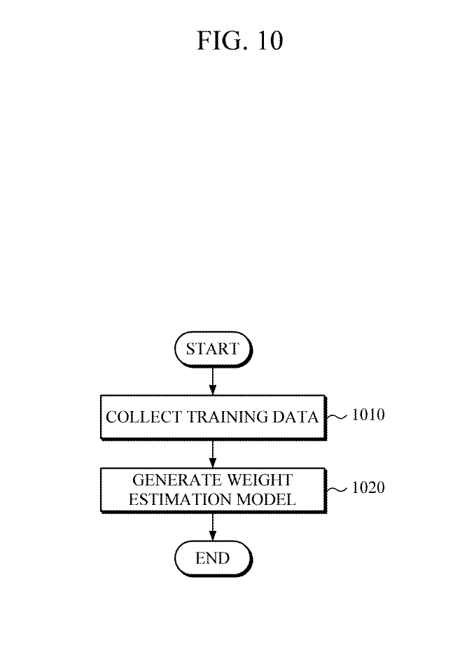

FIG. 10 is a block diagram illustrating another exemplary embodiment of a method for generating a weight estimation model.

Referring to FIGS. 7 and 10, in operation 1010, the apparatus 700 for generating the weight estimation model may collect the training data comprising the body composition analysis result information and weight information of the plurality of objects. The body composition analysis result information may contain an amount of protein, an amount of fat, an amount of water, and the like.

In operation 1020, the apparatus 700 for generating the weight estimation model may generate the weight estimation model through machine learning based on the collected training data. For example, the apparatus 700 for generating the weight estimation model may generate the weight estimation model through the machine learning using the body composition analysis result information as an input and the weight information corresponding to the body composition analysis result information as a target.

According to an exemplary embodiment, the apparatus 700 for generating the weight estimation model may generate the weight estimation model further using additional information including age, height, gender, bio impedance, etc. of the object in addition to the body composition analysis result information and the weight information. In this case, the apparatus 700 for generating the weight estimation model may collect the training data further comprising at least one of age information, height information, gender information, and bio impedance information of the object in addition to the body composition analysis result and the weight information, and generate the weight estimation model through the machine learning using, as inputs, the at least one of the age information, the height information, the gender information, and the bio impedance information as well as the body composition analysis result information and using the weight information as a target.

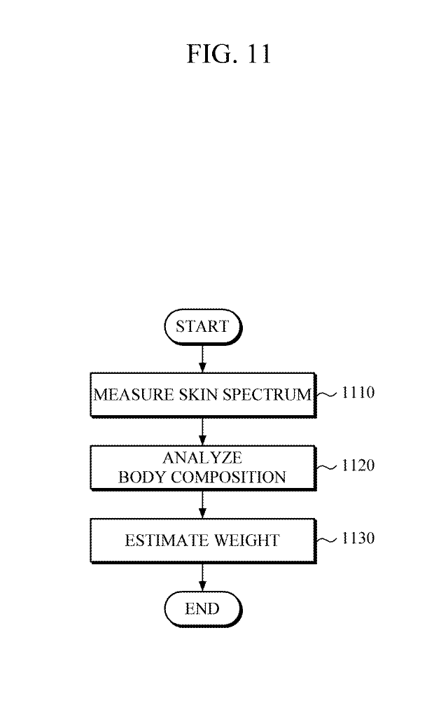

FIG. 11 is a flowchart illustrating still another exemplary embodiment of a method for estimating a weight.

Referring to FIGS. 8 and 11, in operation 1110, the apparatus 800 for estimating the weight may measure a user's skin spectrum.

In operation 1120, the apparatus 800 for estimating the weight may analyze a user's body composition (for example, water, protein, fat, etc.) through the measured skin spectrum.

In operation 1130, the apparatus 800 for estimating the weight may estimate a user's weight based on the body composition analysis result using the weight estimation model generated in advance.

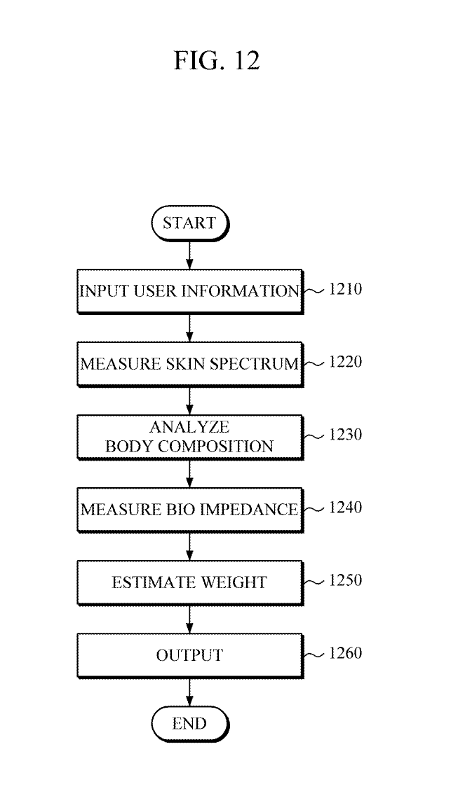

FIG. 12 is a flowchart illustrating yet another exemplary embodiment of a method for estimating a weight.

Referring to FIGS. 9 and 12, the apparatus 900 for estimating the weight may receive a variety of user information used in the weight estimation. The user information may be user related information which can be used in the weight estimation and contain age, gender, height, and the like.

The apparatus 900 for estimating the weight may measure a user's skin spectrum in operation 1220 and analyze a body composition based on the measured skin spectrum in operation 1230.

In operation 1240, the apparatus 900 for estimating the weight may measure a user's bio impedance. For example, the apparatus 900 for estimating the weight may measure the user's bio impedance using a BIA method that applies a current to a user's body and measures electrical impedance of the user.

In operation 1250, the apparatus 900 for estimating the weight may estimate the user's weight using the weight estimation model based on body composition analysis result information, the measured user's bio impedance information, and the received user information. The weight estimation model may be generated based on the training data comprising the body composition analysis result information and weight information of the plurality of objects as described in FIG. 7 or generated based on the training data further comprising additional information including age, height, gender, bio impedance, etc. of the object in addition to the body composition analysis result information and weight information of the plurality of objects.

In operation 1260, the apparatus 900 for estimating the weight may output a weight estimation result. According to an exemplary embodiment, the apparatus 900 for estimating the weight may output the weight estimation result in at least one of audible, visual, and tactile methods.

The computer-readable recording media include all kinds of recording devices in which data that are readable by a computer system are being stored. Examples of the computer-readable recording media include a read-only memory (ROM), a random access memory (RAM), a compact-disc ROM (CD-ROM), a magnetic tape, a floppy disk, an optical data storage device, etc. In addition, the computer-readable recording media may be distributed into the computer system that is connected through the networks to store and implement the computer-readable codes in a distributed computing mechanism.

At least one of the components, elements, modules or units represented by a block as illustrated in the drawings may be embodied as various numbers of hardware, software and/or firmware structures that execute respective functions described above, according to an exemplary embodiment. For example, at least one of these components, elements or units may use a direct circuit structure, such as a memory, a processor, a logic circuit, a look-up table, etc. that may execute the respective functions through controls of one or more microprocessors or other control apparatuses. Also, at least one of these components, elements or units may be specifically embodied by a module, a program, or a part of code, which contains one or more executable instructions for performing specified logic functions, and executed by one or more microprocessors or other control apparatuses. Also, at least one of these components, elements or units may further include or implemented by a processor such as a central processing unit (CPU) that performs the respective functions, a microprocessor, or the like. Two or more of these components, elements or units may be combined into one single component, element or unit which performs all operations or functions of the combined two or more components, elements of units. Also, at least part of functions of at least one of these components, elements or units may be performed by another of these components, element or units. Further, although a bus is not illustrated in the above block diagrams, communication between the components, elements or units may be performed through the bus. Functional aspects of the above exemplary embodiments may be implemented in algorithms that execute on one or more processors. Furthermore, the components, elements or units represented by a block or processing steps may employ any number of related art techniques for electronics configuration, signal processing and/or control, data processing and the like.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for generating a weight estimation model, the apparatus comprising:
a training data collection unit configured to collect training data, the training data comprising skin spectrum information and weight information of a plurality of objects; and
a model generation unit configured to generate the weight estimation model, used for spectrum-based weight estimation, through machine learning based on the collected training data.

2. The apparatus of claim 1, wherein the model generation unit generates the weight estimation model through the machine learning, in which the skin spectrum information is used as an input and the weight information is used as an output.

3. The apparatus of claim 1, wherein the training data further comprises at least one of age information, height information, gender information, and bio impedance information of an object.

4. The apparatus of claim 3, wherein the model generation unit generates the weight estimation model through the machine learning in which the skin spectrum information and the at least one of the age information, the height information, the gender information, and the bio impedance information are used as inputs and the weight information is used as an output.

5. The apparatus of claim 1, wherein an algorithm used to perform the machine learning comprises at least one of partial least squares regression, linear regression, neural network, decision tree, genetic algorithm, genetic programming, K-nearest neighbor, radial basis function network, random forest, support vector machine, and deep-learning.

6. A method for generating a weight estimation model, the method comprising:
collecting training data, the training data comprising skin spectrum information and weight information of a plurality of objects; and
generating the weight estimation model, used for spectrum-based weight estimation, through machine learning based on the collected training data.

7. The method of claim 6, wherein the generating of the weight estimation model comprises generating the weight estimation model through the machine learning, in which the skin spectrum information is used as an input and the weight information is used as an output.

8. The method for generating the weight estimation model of claim 6, wherein the training data further comprises at least one of age information, height information, gender information, and bio impedance information of an object.

9. The method of claim 8, wherein the generating of the weight estimation model comprises generating the weight estimation model through the machine learning in which the skin spectrum information and the at least one of the age information, the height information, the gender information, and the bio impedance information are used as inputs and the weight information is used as an output.

10. The method of claim 6, wherein an algorithm used to perform the machine learning comprises at least one of partial least squares regression, linear regression, neural network, decision tree, genetic algorithm, genetic programming, K-nearest neighbor, radial basis function network, random forest, support vector machine, and deep-learning.

11. An apparatus for estimating a weight, the apparatus comprising:
a spectrum measurement unit configured to measure a skin spectrum of a user; and
a weight estimation unit configured to estimate a weight of the user using a weight estimation model based on the measured skin spectrum.

12. The apparatus of claim 11, wherein the weight estimation model is generated through machine learning based on training data, the training data comprising skin spectrum information and weight information of a plurality of objects.

13. The apparatus of claim 12, wherein the training data further comprises at least one of age information, height information, gender information, and bio impedance information of the plurality objects.

14. The apparatus of claim 13, wherein the weight estimation unit estimates the weight of the user further based on at least one of age information, height information, gender information, and bio impedance information of the user.

15. The apparatus of claim 11, wherein an algorithm used to perform the machine learning comprises at least one of partial least squares regression, linear regression, neural network, decision tree, genetic algorithm, genetic programming, K-nearest neighbor, radial basis function network, random forest, support vector machine, and deep-learning.
